(19) United States
(12) Patent Application Publication
(10) Pub. No.: US 2010/0327231 A1
(43) Pub. Date: Dec. 30, 2010

(54) METHOD OF PRODUCING SYNTHESIS GAS

(76) Inventor: Noah Whitmore, Sammamish, WA (US)

Correspondence Address: GREENBERG TRAURIG (HOU);INTELLECTUAL PROPERTY DEPARTMENT, 1000 Louisiana Street, Suite 1700, Houston, TX, 77002, US

(21) Appl. No.: 12/823,875

(22) Filed: Jun. 25, 2010

Related U.S. Application Data
(60) Provisional application No. 61/220,923, filed on Jun. 26, 2009.

(51) Int. Cl. C01B 3/38; C01B 31/18

(52) U.S. Cl. 252/373; 423/418.2

(57) ABSTRACT

A method of producing synthesis gas is provided. A reactor vessel having a single reaction zone is provided. A catalyst is placed in the single reaction zone. A feed stream is introduced into the single reaction zone, the feed stream comprising a hydrocarbon gas and an oxygen-containing gas. The hydrocarbon gas and the oxygen-containing gas are reacted in the single reaction zone to form a synthesis gas. The synthesis gas is withdrawn from the single reaction zone in a synthesis gas stream.

### RELATED APPLICATION

This Application claims the benefit, and priority benefit, of U.S. Provisional Patent Application Ser. No. 61/220,923, filed Jun. 26, 2009, entitled “Steam Reformer Method” which is incorporated herein in its entirety.

### BACKGROUND

1. Field of the Invention

The present invention relates to a method for producing synthesis gas using a self-sustaining, single stage catalytic reactor.

2. Description of the Related Art

Greenhouse gases or “biogases” such as methane and carbon dioxide are formed from the anaerobic decomposition of organic materials. Landfills are currently the largest source of these biogases. These landfill gases are ideal candidates for reforming reactions that yield synthesis gas. Synthesis gas or “syngas” consists primarily of hydrogen and carbon monoxide, and typically some carbon dioxide, and can be used as a fuel source or as an intermediate for the production of other chemicals.

The following reactions show the predominant routes to converting methane to synthesis gas and the carbon formation reaction in the presence of significant amounts of CO. Reaction (3) is a dry reforming reaction and reactions (2) and (3) combined would constitute the autothermal reforming reaction sequence.

CH₄+H₂O [symbol] CO+3H₂ ΔH=+226 kJ/mol (1)

CH₄+½O₂→CO+2H₂ ΔH=−44 kJ/mol (2)

CH₄+CO₂ [symbol] 2CO+2H₂ ΔH=+261 kJ/mol (3)

2CO [symbol] CO₂+C ΔH=−173 kJ/mol (4)

Various types of reformers and related methods for producing synthesis gas have been in use.

### SUMMARY

In accordance with the illustrative embodiments hereinafter described, a method of producing synthesis gas is provided. The method preferably includes the steps of: providing a reactor vessel having a single reaction zone; providing a catalyst in the single reaction zone; introducing a feed stream into the single reaction zone, the feed stream comprising a hydrocarbon gas and an oxygen-containing gas; reacting the hydrocarbon gas and the oxygen-containing gas in the single reaction zone to form a synthesis gas; and withdrawing the synthesis gas from the single reaction zone in a synthesis gas stream. In certain illustrative embodiments, the catalyst can comprise rhodium, the hydrocarbon gas can comprise methane, the oxygen-containing gas can comprise air, and the feed stream can further comprise water and/or carbon dioxide.

An additional feature is that the method can include the step of preheating the feed stream prior to introducing the feed stream into the single reaction zone. For example, the feed stream can be preheated with the synthesis gas or with heat produced by the reacting of the hydrocarbon gas and the oxygen-containing gas. The feed stream is preferably preheated to a temperature of at least 275 degrees Celsius. The reacting of the hydrocarbon gas and the oxygen-containing gas in the single reaction zone can preferably be self-sustaining after the reaction has been initiated.

In another illustrative embodiment, the method can include the steps of: providing a reactor vessel having a single reaction zone; providing a catalyst in the single reaction zone; introducing a first feed stream into the single reaction zone, the first feed stream comprising a hydrocarbon gas; introducing a second feed stream into the single reaction zone, the second feed stream comprising an oxygen-containing gas; reacting the hydrocarbon gas and the oxygen-containing gas in the single reaction zone to form a synthesis gas; and withdrawing the synthesis gas from the single reaction zone in a synthesis gas stream. In certain illustrative embodiments, the catalyst can comprise rhodium, the hydrocarbon gas can comprise methane, and the oxygen-containing gas can comprise air. Further, the method can include the step of introducing a third feed stream into the second feed stream prior to introducing the second feed stream into the single reaction zone, the third feed stream comprising water and/or carbon dioxide.

An additional feature is that the method can include the step of preheating the first feed stream and the second feed stream prior to introducing the first feed stream and the second feed stream into the single reaction zone. For example, the first feed stream and the second feed stream can be preheated with the synthesis gas or with heat produced by the reacting of the hydrocarbon gas and the oxygen-containing gas. The first feed stream and the second feed stream are preferably preheated to a temperature of at least 275 degrees Celsius. The reacting of the hydrocarbon gas and the oxygen-containing gas in the single reaction zone can preferably be self-sustaining after the reacting has been initiated.

In another illustrative embodiment, the method can include the steps of: providing a reactor vessel having a single reaction zone; providing a catalyst in the single reaction zone; preheating one or more feed streams containing a plurality of reactants with a heat source; introducing the one or more feed streams into the single reaction zone; reacting the plurality of reactants in the single reaction zone to form a synthesis gas; withdrawing the synthesis gas from the single reaction zone in a synthesis gas stream; ceasing preheating of the one or more feed streams with the heat source; and utilizing the synthesis gas stream to preheat the one or more feed streams. In certain illustrative embodiments, the catalyst can comprise rhodium and the plurality of reactants can comprise methane and oxygen, and can further comprise carbon dioxide and/or water. The feed stream is preferably preheated to a temperature of at least 275 degrees Celsius with the heat source to initiate the reaction. The reacting of the plurality of reactants in the single reaction zone can preferably be self-sustaining.

In another illustrative embodiment, the method can include the steps of: providing a first preheater, a second preheater, and a reactor vessel having a single reaction zone; providing a catalyst in the single reaction zone; preheating a plurality of feed streams in the first preheater; introducing the plurality of feed streams into the single reaction zone; reacting the plurality of feed streams in the single reaction zone to form a synthesis gas; withdrawing the synthesis gas from the single reaction zone in a synthesis gas stream; utilizing the synthesis gas stream to preheat the plurality of feed streams in the second preheater; and after preheating has begun in the second preheater, ceasing preheating of the plurality of feed streams in the first preheater. In certain illustrative embodiments, the catalyst can comprise rhodium and the plurality of reactants can comprise methane and oxygen, and can further comprise carbon dioxide and/or water. The feed stream is preferably preheated to a temperature of at least 275 degrees Celsius in the first preheater to initiate the reaction. The reacting of the plurality of reactants in the single reaction zone can preferably be self-sustaining.

In another illustrative embodiment, the method can include the steps of: providing a reactor vessel having a single reaction zone; introducing two or more feed streams into the single reaction zone, wherein the two or more feed streams are from the group consisting of a hydrocarbon gas, an oxygen containing gas, carbon dioxide, and water; reacting the hydrocarbon gas with the oxygen-containing gas in an exothermic partial oxidation reaction; reacting the hydrocarbon gas with the carbon dioxide or water in an endothermic reforming reaction; conducting the exothermic partial oxidation reaction and the endothermic reforming reaction simultaneously in the single reaction zone in the absence of an external heat source being supplied to the single reaction zone; and removing the products of the exothermic partial oxidation reaction and the endothermic reforming reaction from the single reaction zone in a synthesis gas stream.

In another illustrative embodiment, a method of carbon dioxide reforming of methane gas within a reactor vessel is provided whereby greater than 15% carbon dioxide and greater than 90% methane can be converted to carbon monoxide in a single reaction zone within the reaction vessel. In another illustrative embodiment, a method of reforming methane gas in a reactor vessel is provided whereby carbon dioxide and methane gas can be converted to carbon monoxide in a single reaction zone within the reaction vessel, and whereby from 0.79-1.11 moles of carbon monoxide can be produced per mole of methane gas introduced into the reactor vessel. In another illustrative embodiment, a method of reforming methane gas in a reactor vessel is provided whereby carbon dioxide and methane gas can be converted to carbon monoxide in a single reaction zone within the reaction vessel, and whereby from 0.82-1.29 moles of carbon dioxide can be produced per mole of carbon dioxide introduced into the reactor vessel. In another illustrative embodiment, a method of reforming methane gas in a reactor vessel is provided whereby carbon dioxide and methane gas can be converted to carbon monoxide in a single reaction zone within the reaction vessel, and whereby from 0.03-0.09 moles of methane can be produced per mole of methane gas introduced into the reactor vessel.

### BRIEF DESCRIPTION OF THE DRAWINGS

The present illustrative embodiments may be understood by reference to the following description taken in conjunction with the accompanying drawings, in which:

FIG. 1 is an illustrative embodiment of a reactor for producing synthesis gas;

FIG. 2 is an illustrative embodiment of a process for producing synthesis gas;

FIG. 3 is an illustrative embodiment of a process for producing synthesis gas;

FIG. 4 is an illustrative embodiment of a process for producing synthesis gas;

FIG. 5 is an illustrative embodiment of a process for producing synthesis gas;

FIG. 6 is an illustrative embodiment of a process for producing synthesis gas during light off conditions;

FIG. 7 is an illustrative embodiment of a process for producing synthesis gas during normal operating conditions;

FIG. 8 is a graph showing ignition temperatures for RM-75 and RM-45 versus space velocity in connection with experimental testing;

FIG. 9 is a graph showing ignition temperatures for RM-75 and RM-45 versus inlet steam-to-methane ratio in connection with experimental testing;

FIG. 10 is a graph showing the light-off temperature profile for the catalytic auto-ignition of landfill gas over RM-45 in connection with experimental testing;

FIG. 11 is a graph showing the outlet dry mole fraction for RM-45 (FIG. 11A) and RM-75 (FIG. 11B) at Tₚᵣₑₕₑₐₜ=310 deg C., DGHSV=60,000 l/h, air:methane=3.1, and carbon dioxide:methane=0.75 in connection with experimental testing;

FIG. 12 is a graph showing outlet dry mole fraction for RM-45 (FIG. 12A) and RM-75 (FIG. 12B) at Tₚᵣₑₕₑₐₜ=350 deg C., DGHSV=60,000 l/h, air:methane=3.1, and carbon dioxide:methane=0.75 in connection with experimental testing;

FIG. 13 is a graph showing outlet dry mole fraction is shown for RM-45 (FIG. 13A) and RM-75 (FIG. 13B) at Tₚᵣₑₕₑₐₜ=400 deg C., DGHSV=60,000 l/h, air:methane=3.1, and carbon dioxide:methane=0.75 in connection with experimental testing;

FIG. 14 is a graph showing H₂:CO ratio versus Tₚᵣₑₕₑₐₜ for various steam:methane ratios over RM-45 (FIG. 14A) and RM-75 (FIG. 14B) with DGHSV=60,000 l/h, air:methane=3.1, and carbon dioxide:methane=0.75 in connection with experimental testing;

FIG. 15 is a graph showing equilibrium mole fraction versus temperature for steam:methane ratios of 0 (FIG. 15A), 0.7 (FIG. 15B), and 1.4 (FIG. 15C) with air:methane=3.1, carbon dioxide:methane=0.75, and nitrogen:methane=0.13 in connection with experimental testing;

FIG. 16 is a graph showing calculated fraction to equilibrium versus equilibrium temperature for RM-45 (FIG. 16A) and RM-75 (FIG. 16B) with Tₚᵣₑₕₑₐₜ=400 deg C., steam:methane=0, and DGHSV=60,000 l/h in connection with experimental testing;

FIG. 17 is a graph showing calculated fraction to equilibrium versus equilibrium temperature for RM-45 (FIG. 17A) and RM-75 (FIG. 17B) with Tₚᵣₑₕₑₐₜ=400 deg C., steam:methane=0.7, and DGHSV=60,000 l/h in connection with experimental testing;

FIG. 18 is a graph showing calculated fraction to equilibrium versus equilibrium temperature for RM-45 (FIG. 18A) and RM-75 (FIG. 18B) with Tₚᵣₑₕₑₐₜ=400 deg C., steam:methane=1.4, and DGHSV=60,000 l/h in connection with experimental testing; and

FIG. 19 is a graph showing outlet mole fraction versus dry gas hour space velocity for RM-45 (FIG. 19A) and RM-75 (FIG. 19B) with Tₚᵣₑₕₑₐₜ=400 deg C., steam:methane=1.4, and DGHSV=60,000 l/h in connection with experimental testing.

While certain embodiments of the present subject matter will be described in connection with the preferred illustrative embodiments shown herein, it will be understood that it is not intended to limit the subject matter to those embodiments. On the contrary, it is intended to cover all alternatives, modifications, and equivalents, as may be included within the spirit and scope of the subject matter as defined by the appended claims.

### DETAILED DESCRIPTION

In accordance with the present illustrative embodiments, a method is provided for reforming biogas into synthesis gas using a reactor that operates in a self-sustaining manner. Biogases such as methane and carbon dioxide can be utilized for reforming reactions for synthesis gas production. The reforming reactions are endothermic and can require substantial amounts of energy. In a preferred embodiment, exothermic partial oxidation reactions can be utilized within a reactor vessel to provide the necessary energy to promote the desired endothermic reactions. The endothermic reforming reactions and the exothermic partial oxidation reactions can occur simultaneously within the reactor vessel. For example, methane and carbon dioxide can be reacted with air or oxygen to produce a fuel-rich mixture that generates the heat needed to drive the reforming reaction between carbon dioxide and the partial oxidation products, particularly hydrogen and any remaining methane.

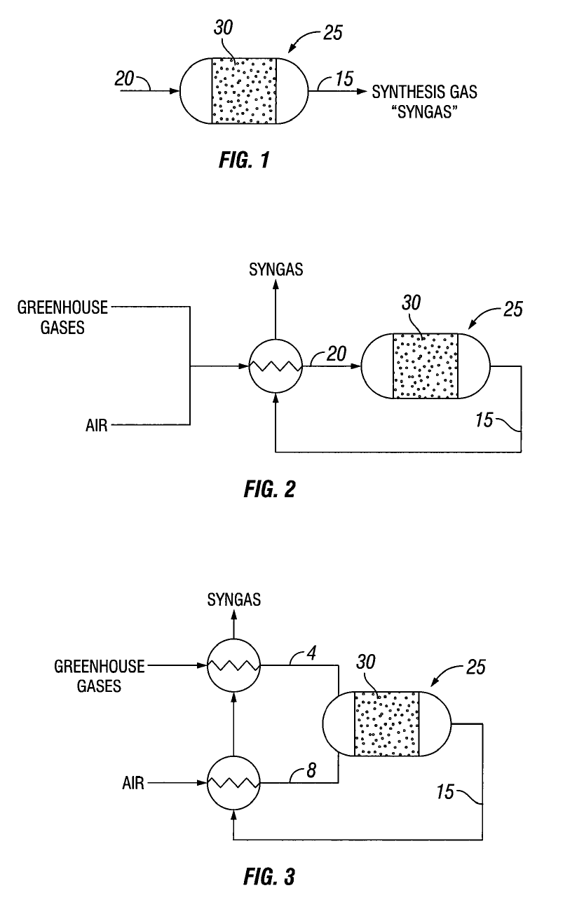

With reference to FIG. 1, a single-stage catalytic reactor 25 is provided. At least one feed stream 20 can be introduced into reactor 25. In a preferred embodiment, feed stream 20 can comprise a hydrocarbon gas (such as methane) and an oxygen-containing gas (such as air). The oxygen in the oxygen-containing gas preferably comprises atmospheric diatomic oxygen (O₂). Feed stream 20 can also comprise carbon dioxide and/or water in other illustrative embodiments.

Reactor 25 can contain a single reaction zone 30. The components in feed stream 20 can react in single reaction zone 30 to form a synthesis gas. The synthesis gas or “syngas” can comprise, for example, hydrogen, carbon monoxide and carbon dioxide, and can exit single reaction zone 30 and be withdrawn from reactor 25 in a synthesis gas stream 15.

A Rhodium-based catalyst is a preferred catalyst for use inside single reaction zone 30. In an illustrative embodiment, the Rhodium-based catalyst can be washcoated on any short-contact substrate (such as monolith, ceramic foam, or screen) or pellet. Rhodium is resistant to coke formation, and can initiate the reforming reactions at temperatures less than 300 degrees C., in certain illustrative embodiments. The partial oxidation kinetics can occur relatively slowly over Rhodium due to its relative ineffectiveness as an oxidation catalyst. The reforming and oxidation reactions can proceed at desirably similar rates, allowing the endothermic reactions and exothermic reactions to balance one another which results in a minimized peak temperature within reactor 25. A non-limiting example of a Rhodium-based catalyst is Selectra RM-45 from BASF Catalysts. Selectra RM-45 is a catalyst that can, for example, be coated onto a ceramic foam or monolith for adiabatic operation.

In certain illustrative embodiments, reactor 25 can operate in a self sustaining manner after the reactions within single reaction zone 30 have been initiated. For example, reactor 25 can operate in the absence of an external heat supply such as a burner, flame or steam heater. Reactor 25 can also be insulated so that the reactions can occur adiabatically.

For example, feed stream 20 to reactor 25 can be pre-heated to a desired “light off” temperature. In certain illustrative embodiments, this light off temperature is preferably about 275 degrees C. Preheating can be accomplished by one or more heat exchangers or any other heat source as would be understood by one skilled in the art. Preheating can optionally be discontinued once the reactions within single reaction zone 30 of reactor 25 have been initiated. Once preheating has been discontinued, reactor 25 can be maintained with an inlet temperature in the range from about 50 degrees C. to about 450 degrees C. In those embodiments where the preheating of feed stream 20 is continued beyond the initial light off of the reactions, the hot synthesis gas in synthesis gas stream 15 may optionally be used as a heating medium from which to provide preheating to feed stream 20.

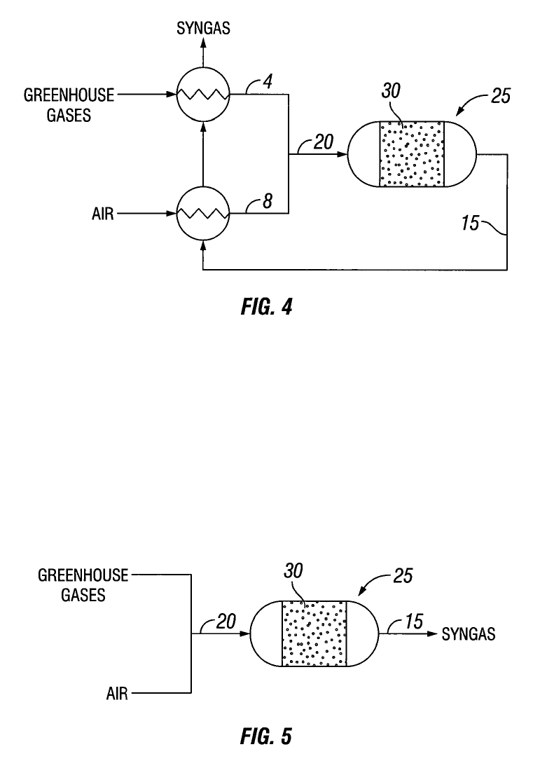

In certain illustrative embodiments, feed stream 20 can comprise multiple streams, and preheating can be accomplished by, for example, individually preheating each individual feed stream, or alternatively, any combination of feed streams can be mixed together to form feed stream 20 before, during or subsequent to being preheated. For example, in an illustrative embodiment as shown in FIG. 2, a single preheated feed stream 20 can be delivered to reactor 25. In an illustrative embodiment as shown in FIG. 3, a plurality of preheated feed streams 4 and 8 can be delivered to reactor 25. In an illustrative embodiment as shown in FIG. 4, a plurality of preheated feed streams 4 and 8 can be combined to form feed stream 20 which is delivered to reactor 25. Other examples of preheating configurations are also within the scope of the present illustrative embodiments.

In each of the embodiments illustrated in FIGS. 2-4, reactor 25 can operate in a self sustaining manner after light off has occurred and the reactions occurring within single reaction zone 30 have been initiated such that synthesis gas is being produced. Synthesis gas stream 15 can provide sufficient preheating for feed stream 20, or feed streams 4 and 8, to maintain the ongoing endothermic reforming reactions and exothermic partial oxidation reactions occurring within single reaction zone 30.

In an alternate embodiment as illustrated in FIG. 5, the use of an external heat exchanger to preheat feed stream 20 is not required. After the reactions are initiated in reactor 25, the reactor temperatures are sufficiently high to maintain the necessary catalytic autoignition of the feed.

Process Simulation.

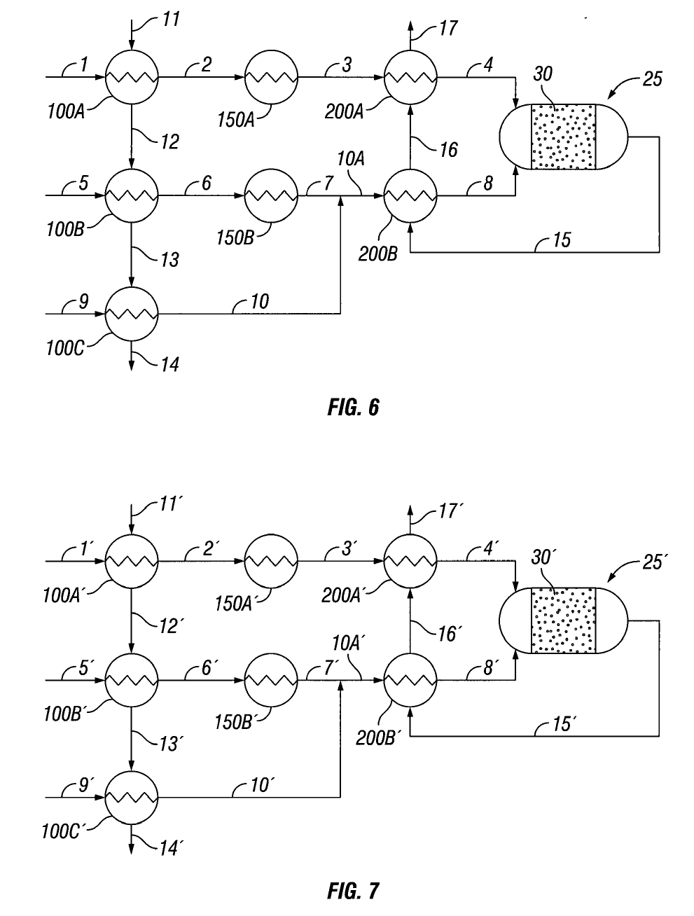

A simulation was performed for the illustrative embodiments illustrated in FIG. 6 and FIG. 7 to demonstrate light off for reactor 25 and subsequent reforming of biogas into synthesis gas in a self-sustaining manner.

The process profile for FIG. 6 is set forth in Table 1 and represents approximate light off conditions for reactor 25.

TABLE 1
Light Off (30 psig)

| Stream | Component | MW | Cp | Temperature | Flow Rate | |
|---|---|---|---|---|---|---|
| 1 | Air | 28.95 g/mol | 29.354 J/mol/K | 250 F. | 119,250 | SCFD |
| 2 | Air | 28.95 g/mol | 29.731 J/mol/K | 400 F. | 119,250 | SCFD |
| 3 | Air | 28.95 g/mol | 30.770 J/mol/K | 710 F. | 119,250 | SCFD |
| 4 | Air | 28.95 g/mol | 30.770 J/mol/K | 710 F. | 119,250 | SCFD |
| 5 | LFG | 28.03 g/mol | 30.060 J/mol/K | 150 F. | 25,000 | SCFD |
| 6 | LFG | 28.03 g/mol | 42.800 J/mol/K | 400 F. | 25,000 | SCFD |
| 7 | LFG | 28.03 g/mol | 49.385 J/mol/K | 710 F. | 25,000 | SCFD |
| 8 | LFG | 28.03 g/mol | 49.385 J/mol/K | 710 F. | 25,000 | SCFD |
| 9 | — | — | — | — | — | |
| 10 | — | — | — | — | — | |
| 10a | LFG | 28.03 g/mol | 49.385 J/mol/K | 710 F. | 25,000 | SCFD |
| 11 | Hot Oil | 240 g/mol | 511 J/mol/K | 408 F. | 340 | GPM |
| 12 | Hot Oil | 240 g/mol | 511 J/mol/K | 407.81 F. | 340 | GPM |
| 13 | Hot Oil | 240 g/mol | 511 J/mol/K | 407.72 F. | 340 | GPM |
| 14 | Hot Oil | 240 g/mol | 511 J/mol/K | 407.72 F. | 340 | GPM |

| | | | | | |
|---|---|---|---|---|---|
| 15 | — | — | — | — | — |
| 16 | — | — | — | — | — |
| 17 | — | — | — | — | — |

Reactor 25 has a Vcat of 2.7 cubic feet and a GHSV of 2,200 in the illustrated embodiment. Heat exchangers 100A and 100B can be utilized to preheat feed stream 1 and feed stream 5, respectively, both to around 400 degrees F. Hot oil in stream 11 and stream 12 can be used to heat feed stream 1 and feed stream 5, respectively. The rate of heat transfer needed to raise the temperature of feed stream 1 is about 4,296 watts. The rate of heat transfer needed to raise the temperature of feed stream 5 is about 2,029 watts.

Electric heaters 150A and 150B can be sized to heat feed stream 2 and feed stream 6, respectively, from around 400 degrees F. to about 710 degrees F., which is beyond the estimated catalytic autoignition temperature of 570 degrees F. The rate of heat transfer needed to raise the temperature of feed stream 2 is about 9,090 watts. The rate of heat transfer needed to raise the temperature of feed stream 6 is about 2,904 watts.

Heat exchangers 100C, 200A and 200B are not utilized for heating purposes in the embodiment illustrated in FIG. 6, as FIG. 6 represents light off for reactor 25 and syngas has not yet been produced.

The process profile for FIG. 7 is set forth in Table 2 and represents approximate normal operating conditions for reactor 25 after light off has occurred, when biogas is being reformed into synthesis gas and reactor 25 is operating in a self-sustaining manner.

TABLE 2
Normal Operating Conditions (30 psig)

| Stream | Component | MW | Cp | Temperature | Flow Rate | |
|---|---|---|---|---|---|---|
| 1′ | Air | 28.95 g/mol | 29.354 J/mol/K | 250 F. | 394,000 | SCFD |
| 2′ | Air | 28.95 g/mol | 29.661 J/mol/K | 375 F. | 394,000 | SCFD |
| 3′ | Air | 28.95 g/mol | 29.661 J/mol/K | 375 F. | 394,000 | SCFD |
| 4′ | Air | 28.95 g/mol | 30.770 J/mol/K | 710 F. | 394,000 | SCFD |
| 5′ | LFG | 28.03 g/mol | 37.060 J/mol/K | 150 F. | 250,000 | SCFD |
| 6′ | LFG | 28.03 g/mol | 42.242 J/mol/K | 375 F. | 250,000 | SCFD |
| 7′ | LFG | 28.03 g/mol | 42.242 J/mol/K | 375 F. | 250,000 | SCFD |
| 8′ | LFG | 28.95 g/mol | 49.385 J/mol/K | 710 F. | 250,000 | SCFD |
| 8′ | H₂O (liq.) | 18.00 g/mol | 76.648 J/mol/K | 274 F. | 365 | lbs/hr |
| 8′ | H₂O (vap.) | 18.00 g/mol | 36.806 J/mol/K | 710 F. | 365 | lbs/hr |
| 9′ | H₂O | 18.00 g/mol | 75.359 J/mol/K | 68 F. | 365 | lbs/hr |
| 10′ | H₂O | 18.00 g/mol | 75.782 J/mol/K | 200 F. | 365 | lbs/hr |
| 10a′ | LFG | 28.03 g/mol | 42.242 J/mol/K | 375 F. | 250,000 | SCFD |
| 10a′ | H₂O (liq.) | 18.00 g/mol | 75.782 J/mol/K | 200 F. | 356 | lb/h |
| 10a′ | H₂O (vap.) | 18.00 g/mol | 34.507 J/mol/K | 274 F. | 365 | lb/h |
| 11′ | Hot Oil | 240 g/mol | 511.0 J/mol/K | 408 F. | 340 | GPM |
| 12′ | Hot Oil | 240 g/mol | 511.0 J/mol/K | 407.47 F. | 340 | GPM |
| 13′ | Hot Oil | 240 g/mol | 511.0 J/mol/K | 406.65 F. | 340 | GPM |
| 14′ | Hot Oil | 240 g/mol | 511.0 J/mol/K | 406.01 F. | 340 | GPM |
| 15′ | Syngas (H₂ - 23%; | 21.83 g/mol | 36.755 J/mol/K | 1431 F. | 2500 | lbs/hr |
| | CO - 11%; CO₂ - 11%; | | | | | |
| | H₂O - 20%; N₂ - 34%) | | | | | |
| 16′ | Syngas (H₂ - 23%; | 21.83 g/mol | 34.170 J/mol/K | 848 F. | 2500 | lbs/hr |
| | CO - 11%; CO₂ - 11%; | | | | | |
| | H2O - 20%; N₂ - 34%) | | | | | |
| 17′ | Syngas (H₂ - 23%; | 21.83 g/mol | 33.640 J/mol/K | 729 F. | 2500 | lbs/hr |
| | CO - 11%; CO₂ - 11%; | | | | | |
| | H2O - 20%; N₂ - 34%) | | | | | |

Heat exchangers 100A′ and 100B′ can be utilized to preheat feed stream 1′ and feed stream 5′, respectively, both to around 350 degrees F. Heat exchanger 100C′ can be utilized to preheat feed stream 9′ to around 200 degrees F. Hot oil in streams 11′, 12′ and 13′ respectively can be used to heat these feed streams. The rate of heat transfer needed to raise the temperature of feed stream 1′ is about 11,813 watts. The rate of heat transfer needed to raise the temperature of feed stream 5′ is about 18,130 watts. The rate of heat transfer needed to raise the temperature of feed stream 9′ is about 14,172 watts.

Electric heaters 150A′ and 150B′ are not utilized for heating purposes in the embodiment illustrated in FIG. 7, as light off has already occurred.

Heat exchangers 200A′ and 200B′ can be utilized to preheat feed stream 3′ and feed stream 10A′, which is a combination of feed stream 7′ and feed stream 10′, to around 710 degrees F. Syngas in stream 15′ can be used to pre-heat these feed streams. The rate of heat transfer needed to raise the temperature of feed stream 3′ is about 32,418 watts. The rate of heat transfer needed to raise the temperature of feed stream 10a′ is about 165,777 watts.

When stream 15′ is cooled in heat exchanger 200A′, the high heat transfer coefficient due to the phase change of liquid water to steam can keep the tube wall temperature of exchanger 200A′ close to the boiling temperature of the water. This causes the syngas to pass through the temperature range when metal dusting via the Boudouard reaction is likely to occur without exposing the syngas to a hot surface where the reaction can occur readily. Thus, carbon deposition and corrosion from the Boudouard reaction are inhibited.

Pilot Plant.

Results from pilot-scale studies are shown in Table 3. Biogases were reduced due to the simultaneous conversion of carbon dioxide and methane in reactor 25, resulting in greater than 15% CO₂ and greater than 90% CH₄ being converted to CO in a single reaction zone in an illustrative embodiment. Further, a production of approximately 0.79-1.11 moles of carbon monoxide per mole of methane inlet, approximately 0.82-1.29 moles of carbon dioxide per mole of carbon dioxide inlet and approximately 0.03-0.09 moles of methane per mole of methane inlet was realized.

TABLE 3
Results from Pilot Plant

| Inlet dry | Dry | Inlet molar ratios | | | Pilot reactor performance | | | | | |
|---|---|---|---|---|---|---|---|---|---|---|
| gas flow | GHSV | H₂O/ | | | H₂/CO | mol CO out/ | mol CO₂ out/ | CO₂ | mol CH₄ out/ | CH₄ |
| SCFD | 1/h | CH₄ | CO₂/CH₄ | O₂/CH₄ | out | mol CH₄ in | mol CO₂ in | conversion (%) | mol CH₄ in | conversion (%) |
| 40,000 | 40,000 | 1.13 | 0.75 | 0.57 | 1.96 | 0.98 | 1.15 | N/A | 0.03 | 96.57 |
| 40,000 | 20,000 | 1.96 | 0.72 | 0.55 | 2.66 | 0.79 | 1.29 | N/A | 0.04 | 96.23 |
| 40,000 | 20,000 | 0.85 | 0.74 | 0.53 | 2.00 | 0.98 | 1.06 | N/A | 0.06 | 94.18 |
| 40,000 | 20,000 | 0 | 0.73 | 0.53 | 1.49 | 1.11 | 0.82 | 18.00 | 0.09 | 91.50 |

Catalyst Testing.

Testing was conducted to determine the preferred catalyst for use in reactor 25 for certain illustrative embodiments set forth herein. In particular, the performance of monolithic catalysts was observed in a reactor system for the autothermal reforming of landfill gas at dry gas hour space velocities from 15,000 l/h to 60,000 l/h with and without the addition of steam. Selectra RM-45 and RM-75 catalysts from BASF Catalysts were utilized.

The reactor consisted of a washcoated monolith fixed inside a 1 inch ID quartz tube, fixed inside a 1.5 inch ID steel pipe. There was a ¼ inch layer of stagnant air between the quartz tube and steel pipe. The gas was preheated in a constant-temperature tube furnace, but the reactor was placed outside of the furnace so the heat of reaction would not affect the heating output of the furnace. The temperature of the preheated gas inside the tube furnace was held constant, and it was found that there was a 100° C. temperature drop between the pre-heating furnace temperature and the catalyst inlet temperature at normal flow. For example, if the tube furnace was set at 500° C., then the catalyst inlet temperature was approximately 400° C. when an inert gas stream at normal operating flowrate was flowing through the reactor. The temperature at the inlet of the catalyst bed is referred to as Tₚᵣₑₕₑₐₜ during inert flow or Tᵢₙₗₑₜ during reforming. The reactor was insulated with about six inches of ceramic fire brick, carved to conform to the dimensions of the metal pipe and fittings.

Pure gas flows of methane, carbon dioxide and nitrogen were controlled via mass flow controllers and adjusted to meet the approximate composition of treated landfill gas. The air flow was also controlled with a mass flow controller, while liquid water was pumped with a water pump. The landfill gas, air, and water were initially preheated in an oven set at a given temperature between 400 degrees C. and 500 degrees C. The dry gases and steam were mixed and sent through a secondary preheating temperature-controlled tube furnace. The inlet of the catalyst bed was placed in the quartz tube four inches downstream from the exit of the tube furnace where the extreme temperature gradient which occurs after the gas leaves the furnace had leveled off such that the difference in temperature between the inlet and outlet of the bed was only about 10° C. for an inert stream at normal flowrate. After the gas passed through the washcoated monolith, a cooling fan was used to cool the gas stream to ambient temperature and liquid water was collected in an Ehrlenmeyer flask. Before sending a gas sample to the GC for analysis, the stream was dried further by passing the gas through a bed of calcium sulfate. The 1 inch ID quartz tube was placed inside of the 316 SS 1.5 inch ID pipe and centered within the pipe by wrapping ceramic insulation around the ends of the quartz tube. The monolith was wrapped with a thin layer of calcined ceramic insulation to ensure no bypass and placed inside the quartz tube. Thermocouples were placed at the entrance and exit of the catalyst.

Results of Catalyst Testing.

Ignition Temperatures.

The catalytic autoignition temperatures were determined for RM-45 and RM-75 for an inlet gas mixture of landfill gas, air, and steam. The air:methane, carbon dioxide:methane, and nitrogen:methane ratios were kept constant at 3.1, 0.75, and 0.13 respectively. The steam:methane ratio was varied from 0 to 1.4 and the dry gas hour space velocity was varied from 15,000 l/h to 60,000 l/h. The ignition temperature was defined as Tᵢₙₗₑₜ when Tₒᵤₜₗₑₜ showed an increase in temperature of more than 1 degree C. per second.

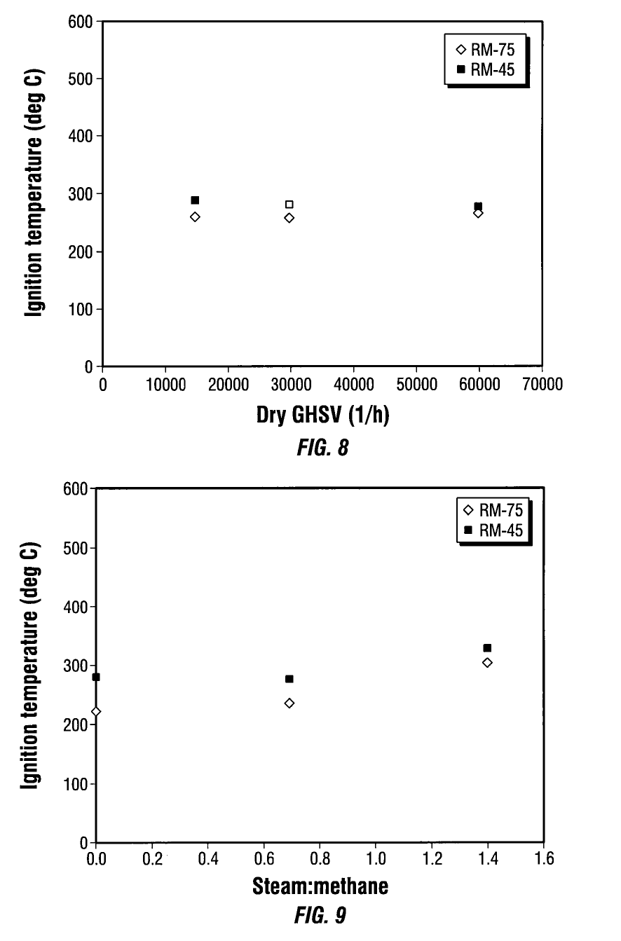

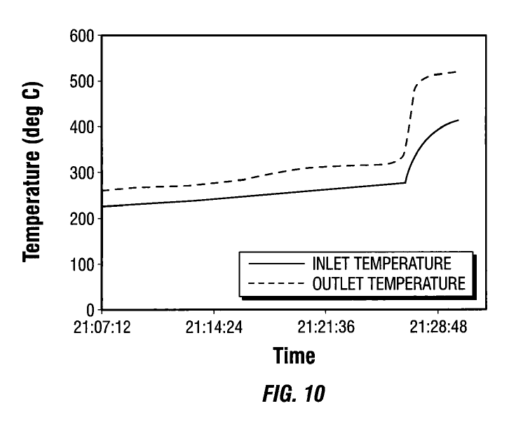

Using a fresh catalyst, the autoignition temperature of RM-75 was fairly constant at 260 degrees C. in the GHSV range from 15,000 to 60,000 l/h (See FIG. 8). After on-stream reforming at varying temperatures and steam:methane ratios, it was found that the reaction lit off at a reduced temperature of 220 degrees C. Increasing the steam:methane ratio from 0 to 1.4 increased the autoignition temperature from 220 to 305 degrees C. (FIG. 9). The RM-45 catalyst had slightly higher autoignition temperatures, and a slight increase in autoignition temperature was seen after repeated experiments. A typical light-off temperature profile is seen in FIG. 10.

Varying Steam:Methane and Tₚᵣₑₕₑₐₜ.

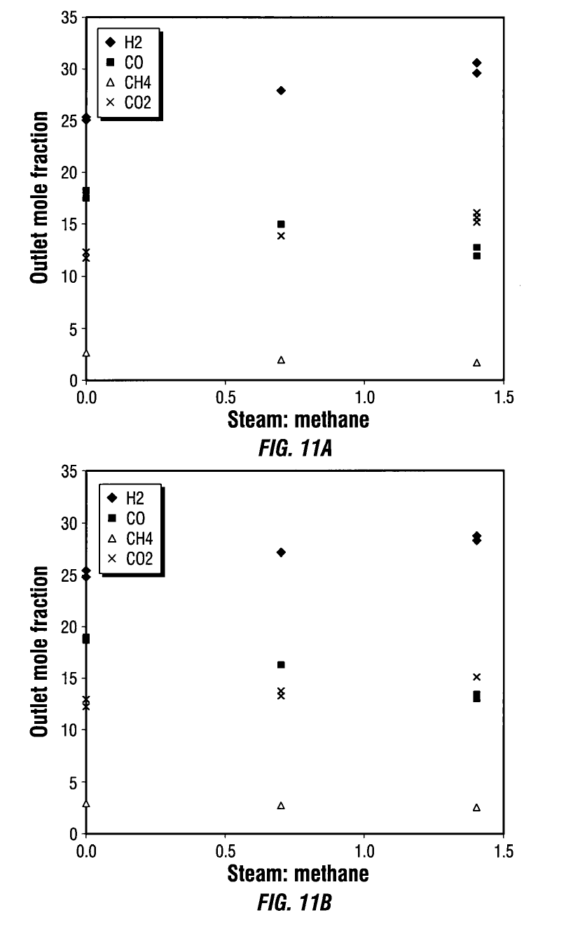

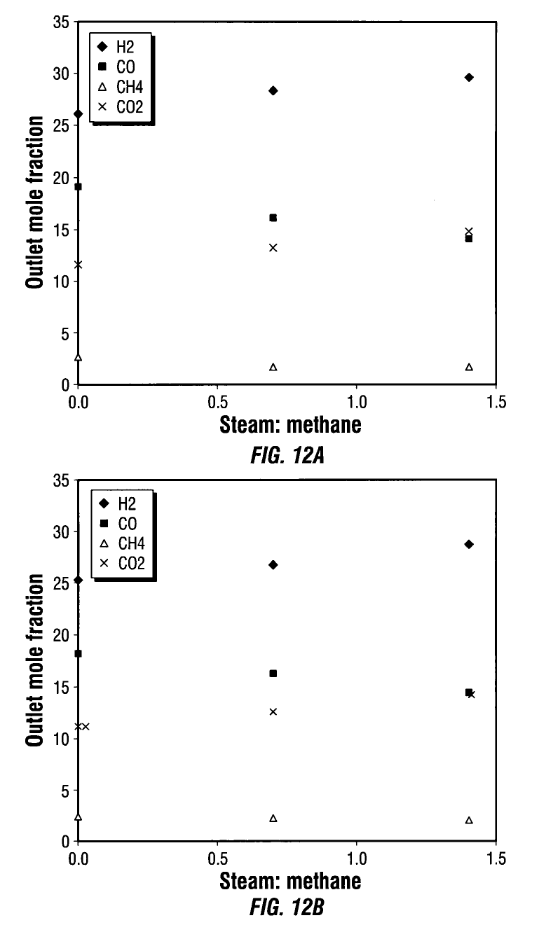

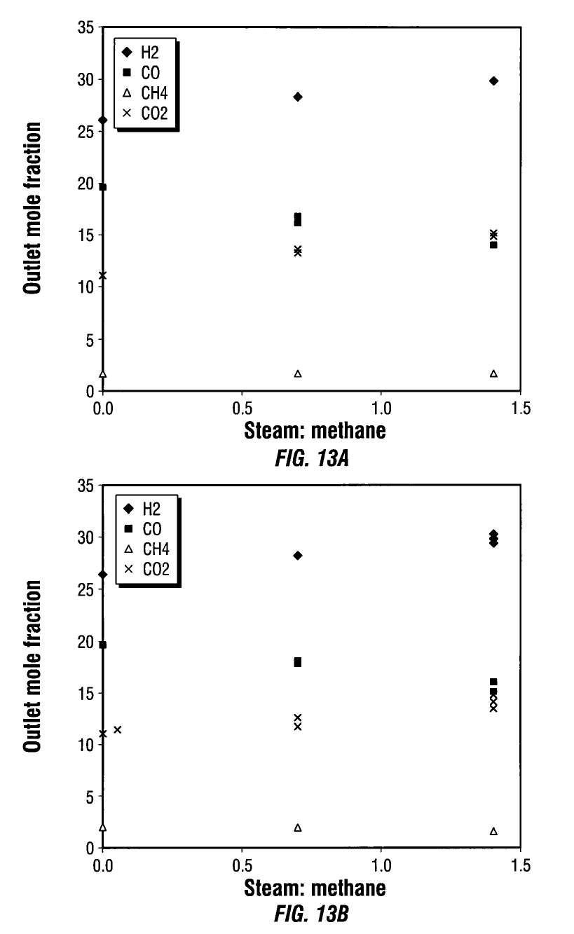

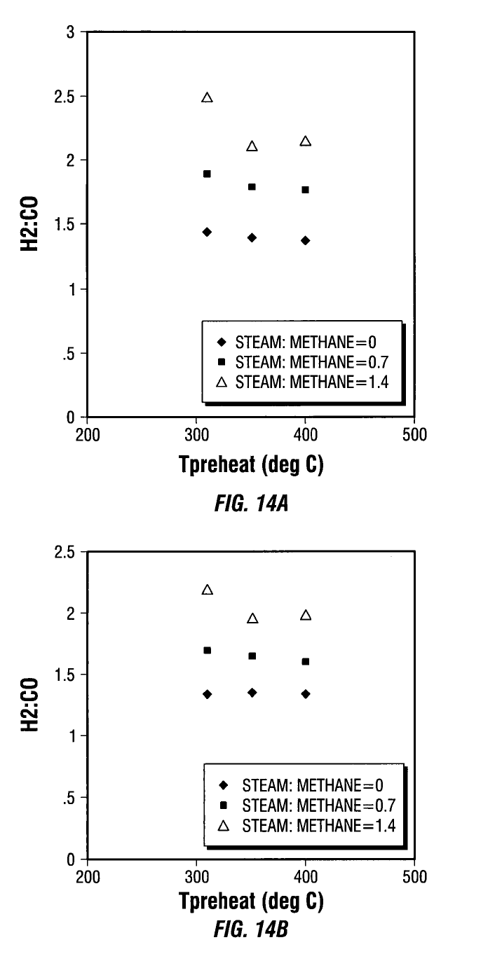

Experiments were performed at steady state to determine outlet dry gas composition at different steam:methane ratios ranging from 0 to 1.4 and gas preheat temperatures (Tₚᵣₑₕₑₐₜ) ranging from 310 to 400 degrees C. It was found that methane conversion, hydrogen production, and H₂:CO ratio increased with increasing steam:methane ratios for all temperatures (FIGS. 11-13). The H₂:CO ratio decreased with increasing temperature, with an exception when the inlet steam:methane was 1.4. At this higher steam:methane ratio of 1.4, a H₂:CO minimum was observed at Tₚᵣₑₕₑₐₜ=350 deg C. (FIG. 14). These trends were seen for each catalyst tested. For an optimal H₂:CO ratio of 2.0, syngas production was maximum when Tₚᵣₑₕₑₐₜ was 400 degrees C. while using the RM-75 catalyst. At this operating condition, approximately 1.7 lb CO can be produced per pound inlet CH₄.

Approach to Equilibrium.

Thermodynamic equilibrium calculations were performed for the various gas feeds and experimental results were compared to theoretical calculations. GASEQ was used to determine the equilibrium concentrations by minimizing Gibbs free energy. The Gibbs free energy G of the mixture at pressure p is given by:

[symbol]

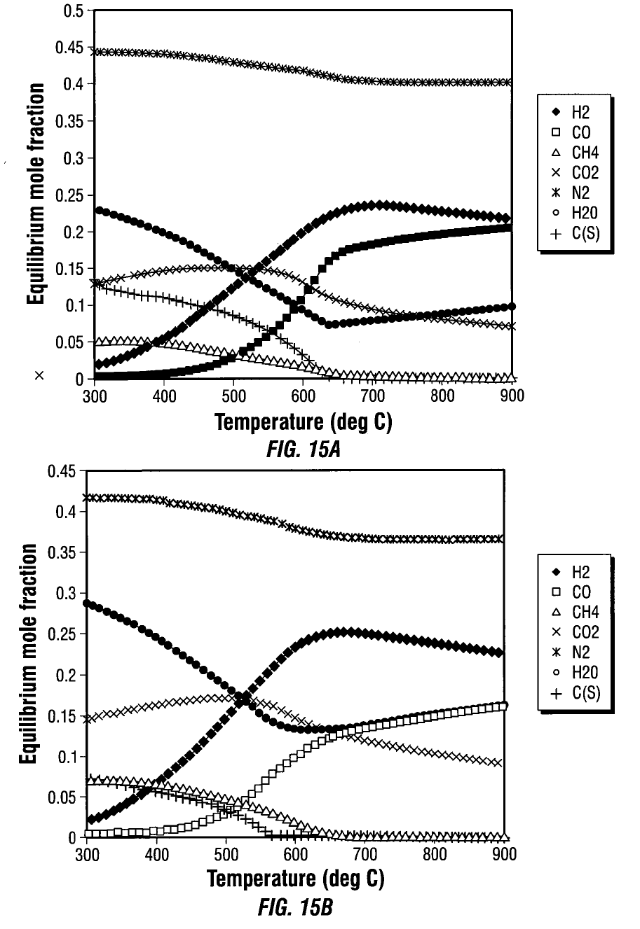

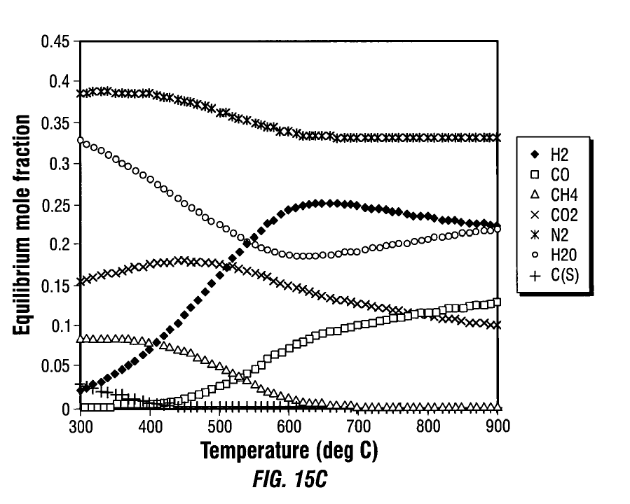

The equilibrium number of moles of species i is xᵢ(i=1 to nSp),Gᵢ⁰ is the molar free energy at 1 atmosphere of species i, and Σxᵢ is the total number of moles in the mixture. At equilibrium G/RT is at a minimum. In FIG. 15, the equilibrium wet mole fraction is shown versus temperature for varying inlet steam:methane ratios. The possibility of solid carbon formation was included in the equilibrium calculations, and it was shown that as the steam:methane ratio increased, the solid carbon fraction decreased. At a steam:methane ratio of 0, solid carbon formation is favored up to about 620 degrees C., but for a steam:methane ratio of 1.4, solid carbon formation becomes unfavorable beyond only 420 degrees C.

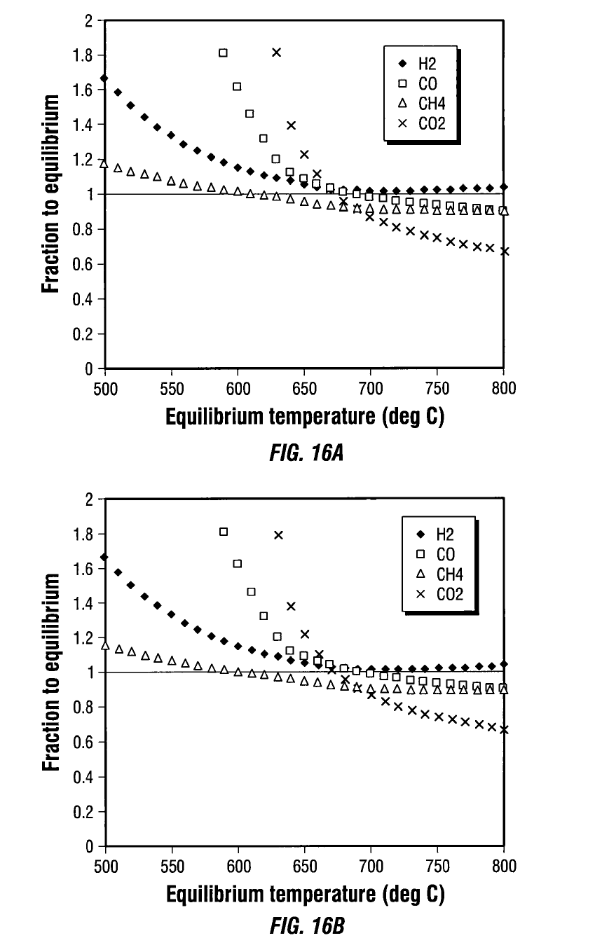

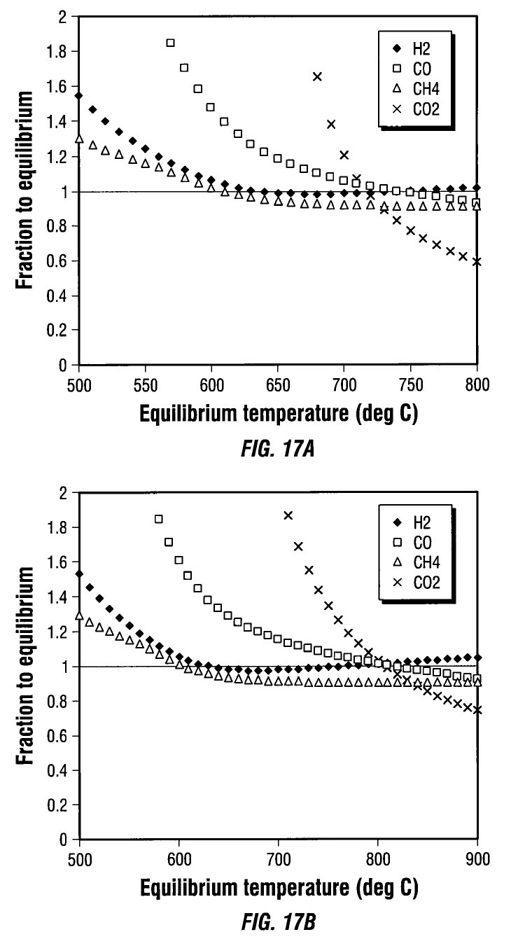

The approach to equilibrium for the experimental data is illustrated in FIGS. 16-18, where fraction to equilibrium is plotted against equilibrium temperature. Where X_{eq} is the equilibrium mole fraction, Xᵢ is the inlet dry mole fraction, and X_{f} is the outlet dry mole fraction, fraction to equilibrium F for the products H₂ and CO was defined as:

$$F = \frac{{X}_{f} - {X}_{i}}{{X}_{eq} - {X}_{i}}$$

and fraction to equilibrium for the reactants CH₄ and CO₂ was defined as:

$$F = \frac{{X}_{i} - {X}_{f}}{{X}_{i} - {X}_{eq}}$$

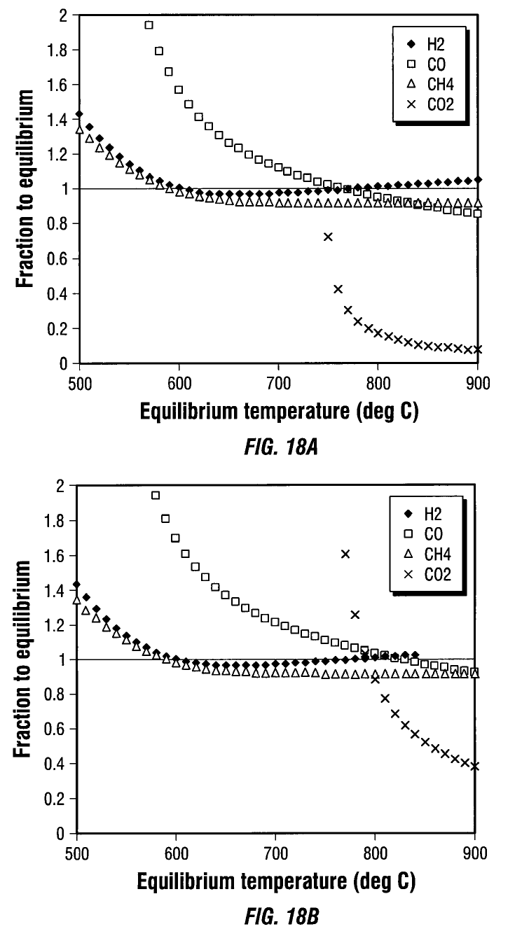

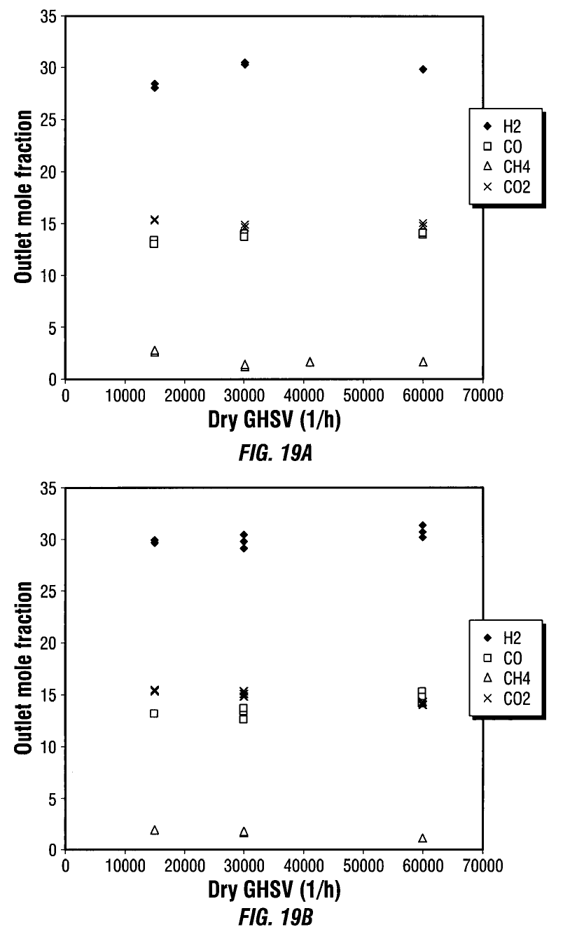

As seen in FIG. 16A, the experimental data closely approaches the equilibrium composition representative of an equilibrium temperature of about 680 degrees C. while using RM-45 and preheating reactants to 400 degrees C. For RM-75 and for a steam:methane ratio of 0 and Tₚᵣₑₕₑₐₜ=400 degrees C., the data approached an equilibrium temperature of about 700 degrees C. (FIG. 16B). It was found that as the steam:methane ratio increased, the equilibrium temperature which the experimental data most closely approached increased. For a steam:methane ratio of 1.4, the data approached an equilibrium temperature of about 790 degrees C. (FIG. 18). For a steam:methane ratio of 1.4 and preheat temperature of 400 degrees C., the ideal adiabatic temperature was calculated to be 781 degrees C., so the agreement was within 2 percent. The RM-45 catalyst indicated an approach to a lower equilibrium temperature of about 750 degrees C., which was within about 5 percent of the theoretical adiabatic temperature.

Varying DGHSV.

Experiments were performed to observe outlet mole fraction and approach to equilibrium versus dry gas hour space velocity. The space velocity was adjusted by changing the length of catalyst. It was found that conversion increased with increasing space velocity, which was likely due to the occurrence of significant heat loss before the gas exited the catalyst bed, causing the gas to reach an equilibrium composition representative of a temperature less than the theoretical adiabatic temperature. It was found that at 60,000 l/h, the outlet gas composition reflected the theoretical adiabatic temperature and composition within about 2 percent for RM-75 and 5 percent for RM-45.

The experimental results indicate that the monolithic catalyst can operate nearly adiabatically with equilibrium conversion at high space velocities. By ensuring that the exothermic partial oxidation reaction occurs simultaneously with the endothermic reforming reaction in the same reaction zone, the peak temperature in the ATR is reduced greatly. Heat transfer is improved between the exothermic and endothermic reactions so operation at high space velocities is possible. The experimental results indicated that careful consideration for conductive heat transfer along the reactor walls should be taken into account while designing the reactor for plant operation. It is recommended that in certain embodiments, the monolith be wrapped with ceramic insulating blanket to bring the reactor inward from the walls of a ceramic-lined pipe.

The RM-75 catalyst showed lower catalytic autoignition temperatures than RM-45, and the ignition temperature for RM-45 decreased after repeated experiments while the autoignition temperature for RM-45 increased after repeated experiments. One possible explanation could be the deposition of carbon on the Pd and Pt sites of the RM-45 catalyst, reducing its ability to oxidize the methane and ignite the reaction. It was found that increasing the steam:methane ratio only slightly increased the autoignition temperature, so it is recommended that steam be used during start-up, in certain embodiments, to reduce the possibility of carbon formation. Since carbon formation is thermodynamically favorable up to about 420 degrees C. for a steam:methane ratio of 1.4, electric heaters will be sized to heat 1/10 of normal flow of landfill gas, air, and steam to 450 degrees C. for startup. The flowrates will then be increased and the heat of reaction will be used to exchange heat to the reactants and maintain an inlet temperature of 450 degrees C.

Outlet gas composition was studied as a function of Tₚᵣₑₕₑₐₜ and steam:methane ratio for each catalyst. It was found that optimal syngas production for a landfill gas composition of 53% methane, 40% carbon dioxide, and 7% nitrogen and for an air:methane ratio of 3.1 occurred with RM-75 when gas was preheated to 400 degrees C. and the steam:methane ratio was 1.4. The outlet dry mole fraction at this condition was about 30% hydrogen and 15% carbon monoxide, yielding about 1.7 lb carbon monoxide per pound inlet methane. The significantly better performance of the Rh-based RM-75 catalyst is attributed to the fact that Rh is not as good of an oxidation catalyst as Pt or Pd. Since RM-45 has significantly more Pt and Pd, the oxidation reactions occur quickly inside the reactor, leading to a greater peak temperature near the entrance and more heat loss by the time the gas exits the reactor. For the Rh-based RM-75, which has less oxidizing catalyst, the oxidation reactions occur more evenly throughout the bed of the catalyst, leading to a more uniform temperature profile, lower maximum temperature, and less heat loss before the gas exits the reactor.

The present illustrative embodiments provide a number of advantages in the context of syngas production. For example, poor performance caused by inefficient reactant pre-heating and undesirable radiant heat transfer from a burner or reaction zone to internal pre-heating coils is substantially avoided. By executing both the endothermic and exothermic reactions in a single reaction zone, heat transfer efficiency is maximized and peak temperature in the reactor is minimized. Also, the potential for carbon deposition and corrosion is substantially reduced.

Specific embodiments of the present subject matter have been described and illustrated herein. It will be understood to those skilled in the art that changes and modifications may be made without departing from the spirit and scope of the subject matter defined by the appended claims.

We claim:

1. A method of producing synthesis gas, the method comprising:
providing a reactor vessel having a single reaction zone;
providing a catalyst in the single reaction zone;
introducing a feed stream into the single reaction zone, the feed stream comprising a hydrocarbon gas and an oxygen-containing gas;
reacting the hydrocarbon gas and the oxygen-containing gas in the single reaction zone to form a synthesis gas; and
withdrawing the synthesis gas from the single reaction zone in a synthesis gas stream.

2. The method of claim 1, wherein the catalyst comprises rhodium.

3. The method of claim 1, wherein the hydrocarbon gas comprises methane.

4. The method of claim 1, wherein the oxygen-containing gas comprises air.

5. The method of claim 1, wherein the feed stream further comprises carbon dioxide.

6. The method of claim 1, wherein the feed stream further comprises water.

7. The method of claim 1, further comprising preheating the feed stream prior to introducing the feed stream into the single reaction zone.

8. The method of claim 6, wherein the feed stream is preheated with heat produced by the reacting of the hydrocarbon gas and the oxygen-containing gas.

9. The method of claim 6, wherein the feed stream is preheated with the synthesis gas.

10. The method of claim 6, wherein the feed stream is preheated to a temperature of at least 275 degrees Celsius.

11. The method of claim 1, wherein the reacting of the hydrocarbon gas and the oxygen-containing gas in the single reaction zone is self-sustaining.

12. A method of producing synthesis gas, the method comprising:
providing a reactor vessel having a single reaction zone;
providing a catalyst in the single reaction zone;
introducing a first feed stream into the single reaction zone, the first feed stream comprising a hydrocarbon gas;
introducing a second feed stream into the single reaction zone, the second feed stream comprising an oxygen-containing gas;
reacting the hydrocarbon gas and the oxygen-containing gas in the single reaction zone to form a synthesis gas; and
withdrawing the synthesis gas from the single reaction zone in a synthesis gas stream.

13. The method of claim 11, wherein the catalyst comprises rhodium.

14. The method of claim 11, wherein the hydrocarbon gas comprises methane.

15. The method of claim 11, wherein the oxygen-containing gas comprises air.

16. The method of claim 11, further comprising introducing a third feed stream into the second feed stream prior to introducing the second feed stream into the single reaction zone, the third feed stream comprising carbon dioxide.

17. The method of claim 11, wherein the third feed stream further comprises water.

18. The method of claim 11, further comprising preheating the first feed stream and the second feed stream prior to introducing the first feed stream and the second feed stream into the single reaction zone.

19. The method of claim 17, wherein the first feed stream and the second feed stream are preheated with heat produced by the reacting of the hydrocarbon gas and the oxygen-containing gas.

20. The method of claim 17, wherein the first feed stream and the second feed stream are preheated with the synthesis gas.

21. The method of claim 17, wherein the first feed stream and the second feed stream are preheated to a temperature of at least 275 degrees Celsius.

22. The method of claim 11, wherein the reacting of the hydrocarbon gas and the oxygen-containing gas in the single reaction zone is self-sustaining.

23. A method of producing synthesis gas, the method comprising:
providing a reactor vessel having a single reaction zone;
providing a catalyst in the single reaction zone;
preheating one or more feed streams containing a plurality of reactants with a heat source;
introducing the one or more feed streams into the single reaction zone;
reacting the plurality of reactants in the single reaction zone to form a synthesis gas;
withdrawing the synthesis gas from the single reaction zone in a synthesis gas stream;
ceasing preheating of the one or more feed streams with the heat source; and
utilizing the synthesis gas stream to preheat the one or more feed streams.

24. The method of claim 22, wherein the catalyst comprises rhodium.

25. The method of claim 22, wherein the plurality of reactants comprises methane and oxygen.

26. The method of claim 24, wherein the plurality of reactants further comprises carbon dioxide.

27. The method of claim 24, wherein the plurality of reactants further comprises water.

28. The method of claim 22, wherein the feed stream is preheated to a temperature of at least 275 degrees Celsius with the heat source to initiate the reaction.

29. The method of claim 22, wherein the reacting of the plurality of reactants in the single reaction zone is self-sustaining.

30. A method of producing synthesis gas, the method comprising:
providing a first preheater, a second preheater, and a reactor vessel having a single reaction zone;
providing a catalyst in the single reaction zone;
preheating a plurality of feed streams in the first preheater;
introducing the plurality of feed streams into the single reaction zone;
reacting the plurality of feed streams in the single reaction zone to form a synthesis gas;
withdrawing the synthesis gas from the single reaction zone in a synthesis gas stream;
utilizing the synthesis gas stream to preheat the plurality of feed streams in the second preheater; and
after preheating has begun in the second preheater, ceasing preheating of the plurality of feed streams in the first preheater.

31. The method of claim 28, wherein the plurality of feed streams comprises methane and oxygen.

32. The method of claim 28, wherein the plurality of feed streams further comprises carbon dioxide.

33. The method of claim 28, wherein the plurality of feed streams further comprises water.

34. The method of claim 28, wherein the catalyst comprises rhodium.

35. The method of claim 28, wherein the plurality of feed streams are preheated to a temperature of at least 275 degrees Celsius in the first preheater to initiate the reaction.

36. The method of claim 28, wherein the reacting of the plurality of feed streams in the single reaction zone is self-sustaining.

37. A method of producing synthesis gas, the method comprising:
providing a reactor vessel having a single reaction zone; introducing two or more feed streams into the single reaction zone, wherein the two or more feed streams are from the group consisting of a hydrocarbon gas, an oxygen containing gas, carbon dioxide, and water;
reacting the hydrocarbon gas with the oxygen-containing gas in an exothermic partial oxidation reaction;
reacting the hydrocarbon gas with the carbon dioxide or water in an endothermic reforming reaction;
conducting the exothermic partial oxidation reaction and the endothermic reforming reaction simultaneously in the single reaction zone in the absence of an external heat source being supplied to the single reaction zone; and
removing the products of the exothermic partial oxidation reaction and the endothermic reforming reaction from the single reaction zone in a synthesis gas stream.

38. A method of carbon dioxide reforming of methane gas within a reactor vessel, whereby greater than 15% carbon dioxide and greater than 90% methane are converted to carbon monoxide in a single reaction zone within the reaction vessel.

39. A method of reforming methane gas in a reactor vessel, the method comprising the step of converting carbon dioxide and methane gas to carbon monoxide in a single reaction zone within the reaction vessel, whereby from 0.79-1.11 moles of carbon monoxide are produced per mole of methane gas introduced into the reactor vessel.

40. A method of reforming methane gas in a reactor vessel, the method comprising the step of converting carbon dioxide and methane gas to carbon monoxide in a single reaction zone within the reaction vessel, whereby from 0.82-1.29 moles of carbon dioxide are produced per mole of carbon dioxide introduced into the reactor vessel.

41. A method of reforming methane gas in a reactor vessel, the method comprising the step of converting carbon dioxide and methane gas to carbon monoxide in a single reaction zone within the reaction vessel, whereby from 0.03-0.09 moles of methane are produced per mole of methane gas introduced into the reactor vessel.
